(19) United States
(12) Patent Application Publication
(10) Pub. No.: US 2024/0125306 A1
(43) Pub. Date: Apr. 18, 2024

(54) Shape Memory Alloy Actuators And Methods Thereof

(71) Applicant: Hutchinson Technology Incorporated, Hutchinson, MN (US)

(72) Inventor: Mark A. Miller, Hutchinson, MN (US)

(21) Appl. No.: 17/966,681

(22) Filed: Oct. 14, 2022

(51) Int. Cl. F03G 7/06; G03B 5/00; G03B 13/36

(52) U.S. Cl. CPC F03G 7/06143; F03G 7/06114; G03B 5/00; G03B 13/36; G03B 2205/0007; G03B 2205/0076

(57) ABSTRACT

SMA actuators and related methods are described. One embodiment of an actuator includes a base; a plurality of buckle arms; and at least a first shape memory alloy wire coupled with a pair of buckle arms of the plurality of buckle arms. Another embodiment of an actuator includes a base and at least one bimorph actuator including a shape memory alloy material. The bimorph actuator attached to the base.

### FIELD

Embodiments of the invention relate to the field of shape memory alloy systems. More particularly, embodiments of the invention relate to the field of shape memory allow actuators and methods related thereto.

### BACKGROUND

Shape memory alloy (“SMA”) systems have a moving assembly or structure that for example can be used in conjunction with a camera lens element as an auto-focusing drive. These systems may be enclosed by a structure such as a screening can. The moving assembly is supported for movement on a support assembly by a bearing such as plural balls. The flexure element, which is formed from metal such as phosphor bronze, nickel copper alloys, titanium copper alloys, beryllium copper alloys, or stainless steel, has a moving plate and flexures. The flexures extend between the moving plate and the stationary support assembly and function as springs to enable the movement of the moving assembly with respect to the stationary support assembly. The balls allow the moving assembly to move with little resistance. The moving assembly and support assembly are coupled by four shape memory alloy (SMA) wires extending between the assemblies. Each of the SMA wires has one end attached to the support assembly, and an opposite end attached to the moving assembly. The suspension is actuated by applying electrical drive signals to the SMA wires. However, these type of systems are plagued by the complexity of the systems that result in bulky systems that require a large foot print and a large height clearance. Further, the present systems fail to provide high Z-stroke range with a compact, low profile footprint

### SUMMARY

SMA actuators and related methods are described. One embodiment of an actuator includes a base; a plurality of buckle arms; and at least a first shape memory alloy wire coupled with a pair of buckle arms of the plurality of buckle arms. Another embodiment of an actuator includes a base and at least one bimorph actuator including a shape memory alloy material. The bimorph actuator attached to the base.

In a first example embodiment, a system is provided. In some instances, the system can include a camera actuating system, with a first actuator comprising an autofocus actuator configured to actuate a lens in the z-direction, and a second actuator comprising an optical image stabilization actuator configured to actuate the lens in any of an x-direction and a y-direction. The system can include a first actuator comprising a first set of base portions and a second actuator comprising a second base portion.

The system can further include a set of wire springs. Each of the set of wire springs can include a first end connected to a corresponding portion of the first set of base portions of the first actuator. In some instances, the first end is welded to corresponding portions of the first set of base portions of the first actuator. Each wire spring can also include a second end connected to the second base portion. In some instances, the second end is soldered to the second base portion. Each of the set of wire springs can allow an electrical current to flow between the first actuator and the second actuator. Each of the wire springs can also include at least two flattening bends creating a down force to maintain each wire spring disposed in a positive z-direction. In some instances, each of the set of wire springs comprise a down force of around 25 millinewtons.

In some instances, each of the set of wire springs can comprise two angled bent portions. Further, each wire spring can include a substantially flat profile. In some instances, each of the set of wire springs are configured to, in response to actuation of any of the first actuator and/or second actuator, have a maximum profile of 0.2 mm in the positive z-direction.

In another example embodiment, a wire spring is provided. The wire spring can include a first end configured to connect to a corresponding portion of a first set of base portions of a first actuator. In some instances, the first end is welded to corresponding portions of the first set of base portions of the first actuator. The wire spring can also include a second end configured to connect to a second base portion of a second actuator. In some instances, the second end is soldered to the second base portion. The wire spring can allow an electrical current to flow between the first actuator and the second actuator. The wire spring can also include at least two flattening bends creating a down force to maintain each wire spring disposed in a positive z-direction.

In some instances, the wire spring is part of a set of wire springs. Each of the set of wire springs can be configured to connect to corresponding portions of the first set of base portions of the first actuator. In some instances, the wire spring comprises two angled bent portions, wherein the wire spring comprises a substantially flat profile. In some instances, the wire spring is configured to, in response to actuation of any of the first actuator and/or second actuator, have a maximum profile of 0.2 mm in the positive z-direction. In some instances, the wire spring comprises a down force of around 25 millinewtons.

In another example embodiment, a camera actuation system is provided. The camera actuation system can include an autofocus actuator comprising a first set of base portions. The autofocus actuator can be configured to actuate a lens in a z-direction. The camera actuation system can also include an optical image stabilization actuator comprising a second base portion. The optical image stabilization actuator can be configured to actuate the lens in any of an x-direction and a y-direction.

The camera actuation system can also include a set of wire springs. Each of the set of wire springs can be connected at a first end to a corresponding portion of the first set of base portions of the autofocus actuator and connected at a second end to the second base portion.

In some instances, the set of wire springs comprise a stainless-steel material. Each of the set of wire springs can allow an electrical current to flow between the autofocus actuator and the optical image stabilization actuator. In some instances, each of the set of wire springs comprise at least two flattening bends creating a down force to maintain each wire spring disposed in a positive z-direction. In some instances, each of the set of wire springs comprise two angled bent portions, wherein each wire spring comprises a substantially flat profile. In some instances, the first end of each of the set of wire springs is welded to corresponding portions of the first set of base portions of the first actuator, and the second end of each of the set of wire springs is soldered to the second base portion. In some instances, any of the autofocus actuator and/or the optical image stabilization actuator comprise shape memory alloy (SMA) actuators including an SMA material configured to actuate in response to an electrical current being provided to the SMA material.

Other features and advantages of embodiments of the present invention will be apparent from the accompanying drawings and from the detailed description that follows.

### BRIEF DESCRIPTION OF THE DRAWINGS

Embodiments of the present invention are illustrated by way of example and not limitation in the figures of the accompanying drawings, in which like references indicate similar elements and in which:

FIG. 1A illustrates a prior art lens assembly including an SMA actuator configured as a buckle actuator.

FIG. 1B illustrates a prior art SMA actuator.

FIG. 2 illustrates a prior art SMA actuator.

FIG. 3 illustrates an exploded view of a prior art autofocus assembly including an SMA wire actuator.

FIG. 4 illustrates the prior art autofocus assembly including a SMA actuator.

FIG. 5 illustrates a prior art SMA actuator including a sensor.

FIG. 6 illustrates an exploded view of an example camera actuation system according to embodiments.

FIG. 7 illustrates a top view of an actuator comprising a set of wire springs engaged to an OIS actuator according to embodiments.

FIG. 8 illustrates the set of wire springs in a free formed state according to embodiments.

FIG. 9 illustrates an example flattened wire spring according to embodiments.

FIG. 10 illustrates a close-up view of a wire spring engaged with a base according to embodiments.

FIGS. 11A-11B illustrate side views of wire springs before and after a preload force is applied according to embodiments.

FIG. 12 is a graphical illustration illustrating a comparison of an arm profile and z-direction height of various wire springs according to embodiments.

### DETAILED DESCRIPTION

Embodiments of an SMA actuator are described herein that include a compact footprint and providing a high actuation height, for example movement in the positive z-axis direction (z-direction), referred to herein as the z-stroke. Embodiments of the SMA actuator include an SMA buckle actuator and an SMA bimorph actuator. The SMA actuator may be used in many applications including, but not limited to, a lens assembly as an autofocus actuator, a micro-fluidic pump, a sensor shift, optical image stabilization, optical zoom assembly, to mechanically strike two surfaces to create vibration sensations typically found in haptic feedback sensors and devices, and other systems where an actuator is used. For example, embodiments of an actuator described herein could be used as a haptic feedback actuator for use in cellphones or wearable devices configured to provide the user an alarm, notification, alert, touched area or pressed button response. Further, more than one SMA actuator could be used in a system to achieve a larger stroke.

For various embodiments, the SMA actuator has a z-stroke that is greater than 0.4 millimeters. Further, the SMA actuator for various embodiments has a height in the z-direction of 2.2 millimeters or less, when the SMA actuator is in its initial, a de-actuated position. Various embodiments of the SMA actuator configured as an autofocus actuator in a lens assembly may have a footprint as small as 3 millimeters greater than the lens inner diameter (“ID”). According to various embodiments, the SMA actuator may have a footprint that is wider in one direction to accommodate components including, but not limited to, sensors, wires, traces, and connectors. According to some embodiments, the footprint of an SMA actuator is 0.5 millimeters greater in one direction, for example the length of the SMA actuator is 0.5 millimeters greater than the width.

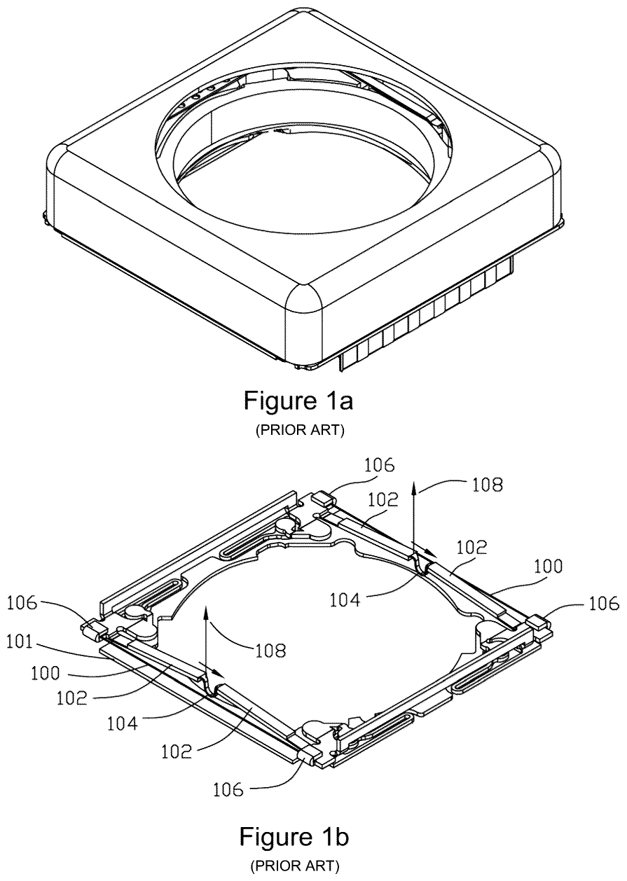

The embodiments described with respect to FIGS. 1A-5 depict prior art representations relating to actuators described in U.S. Pat. No. 10,920,755, the entire disclosure of which is incorporated by reference herein.

FIG. 1A illustrates a lens assembly including an SMA actuator configured as a buckle actuator according to an embodiment. FIG. 1B illustrates an SMA actuator configured as a buckle actuator according to an embodiment. The buckle actuators 102 are coupled with a base 101. As illustrated in FIG. 1B, SMA wires 100 are attached to buckle actuators 102 such that when the SMA wires 100 are actuated and contract this causes the buckle actuators 102 to buckle, which results in at least the center portion 104 of each buckle actuator 102 to move in the z-stroke direction, for example the positive z-direction, as indicated by the arrows 108. According to some embodiments, the SMA wires 100 are actuated when electrical current is supplied to one end of the wire through a wire retainer such as a crimp structure 106. The current flows through the SMA wire 100 heating it due to the resistance inherent in the SMA material of which the SMA wire 100 is made. The other side of the SMA wire 100 has a wire retainer such as a crimp structure 106 that connects the SMA wire 100 to complete the circuit to ground. Heating of the SMA wire 100 to a sufficient temperature causes the unique material properties to change from martensite to austenite crystalline structure, which causes a length change in the wire. Changing the electrical current can change the temperature and therefore changes the length of the wire, which is used to actuate and de-actuate the actuator to control the movement of the actuator in at least the z-direction. One skilled in the art would understand that other techniques could be used to provide electrical current to an SMA wire.

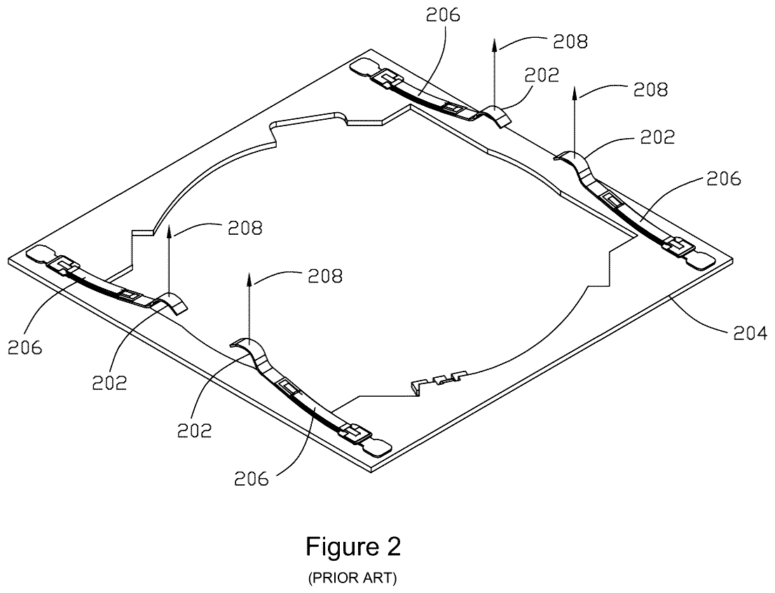

FIG. 2 illustrates an SMA actuator configured as an SMA bimorph actuator according to an embodiment. As illustrated in FIG. 2, the SMA actuator includes bimorph actuators 202 coupled with a base 204. The bimorph actuators 202 include an SMA ribbon 206. The bimorph actuators 202 are configured to move at least the unfixed ends of the bimorph actuators 202 in the z-stroke direction 208 as the SMA ribbon 206 shrinks.

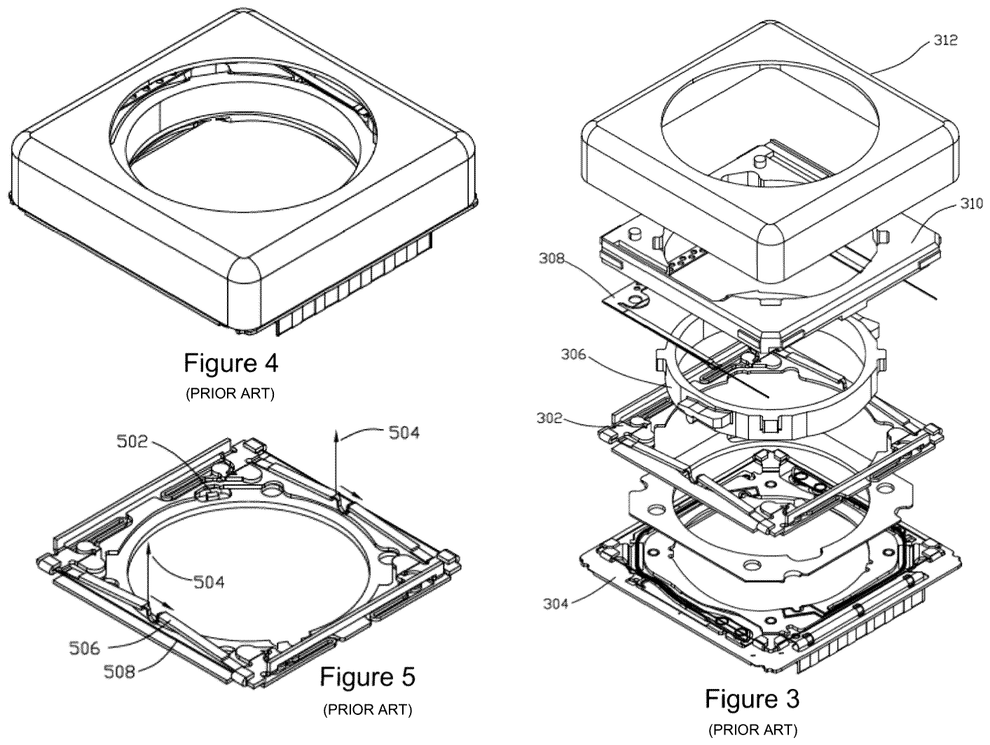

FIG. 3 illustrates an exploded view of an autofocus assembly including an SMA actuator according to an embodiment. As illustrated, an SMA actuator 302 is configured as a buckle actuator 302 according to embodiments described herein. The autofocus assembly also includes optical image stabilization (“OIS”) 304, a lens carriage 306 configured to hold one or more optical lens using techniques including those known in the art, a return spring 308, a vertical slide bearing 310, and a guide cover 312. The lens carriage 306 is configured to slide against the vertical slide bearing 310 as the buckle actuator 302 moves in the z-stroke direction, for example the positive z-direction, when the SMA wires are actuated and pull and buckle the buckle actuators 302 using techniques including those described herein. The return spring 308 is configured to apply a force in the opposite direction to the z-stroke direction on the lens carriage 306 using techniques including those known in the art. The return spring 308 is configured, according to various embodiments, to move the lens carriage 306 in the opposite direction of the z-stroke direction when the tension in the SMA wires is lowered as the SMA wire is de-actuated. When the tension in the SMA wires is lowered to the initial value, the lens carriage 306 moves to the lowest height in the z-stroke direction. FIG. 4 illustrates the autofocus assembly including an SMA wire actuator according to an embodiment illustrated in FIG. 3.

FIG. 5 illustrates an SMA wire actuator according to an embodiment including a sensor. For various embodiments, the sensor 502 is configured to measure the movement of the SMA actuator in the z-direction or the movement of a component that that SMA actuator is moving using techniques including those known in the art. The SMA actuator including one or more buckle actuators 506 configured to actuate using one or more SMA wires 508 similar to those described herein. For example, in the autofocus assembly described in reference to FIG. 4, the sensor is configured to determine the amount of movement the lens carriage 306 moves in the z-direction 504 from an initial position using techniques including those known in the art. According to some embodiments, the sensor is a tunnel magneto resistance (“TMR”) sensor.

As described herein, a camera actuation system can include an autofocus (AF) actuator and/or an optical image stabilization (OIS) actuator. For instance, the AF actuator can include one or more buckler actuators to move a lens in a z-direction. Further, the OIS actuator can include one or more bimorph actuators to move a lens in any of an x-direction and a y-direction. Any of the actuators as described herein can include shape metal alloy (SMA) materials (e.g., wires) configured to move a free end of the actuator in response to an electrical current being provided to the SMA wires.

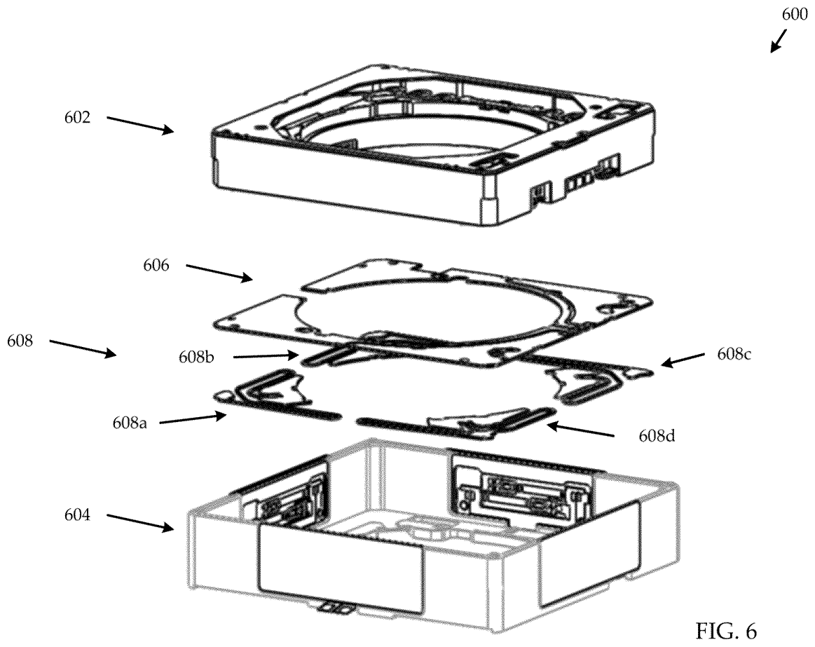

FIG. 6 illustrates an exploded view of an example camera actuation system 600. As shown in FIG. 6, the system 600 can include an AF actuator 602 and an OIS actuator 604. The AF actuator 602 can include a base 606 with multiple electrically isolated portions. The portions of the base 606 can be formed or etched into sections from a unitary piece. The portions of base 606 can comprise four isolated circuits to drive actuators (e.g., buckler actuators) in the AF actuator 602.

The OIS actuator 604 can include a base and one or more actuators (e.g., bimorph actuators). Further, the OIS actuator 604 can be configured to actuate in both an x and y direction. The OIS actuator 604 can include a plurality of actuators, such as a number of bimorph actuators as part of a box actuator.

The system 600 can further include a set of wire springs 608. The wire springs 608 can be connected to both the AF actuator 602 and the OIS actuator 604. For instance, the set of wire springs 608 can include wires 608a-d. Each of the set of wire springs 608a-d can connect to corresponding portions of the base 606 of the AF actuator 602. The springs 608a-d can deliver an electrical current between the AF actuator 602 and the OIS actuator 604.

In some instances, each wire spring 608a-d can include a first end (e.g., comprising feet) with a welded connection to sections of the base 606 of the AF actuator 602. Further, each wire spring 608a-d can include a foot portion with a solder connection to a base portion (e.g., an OIS control flexible printed circuit (FPC)) of the OIS actuator 604.

The wire springs as described herein can include a 100-micrometer stainless steel (with gold plating) material that can provide isolated electrical paths for closed loop actuators at the AF actuator. The wire springs can further provide increase OIS centering stiffness, while also providing lower stress on the wire springs during large x/y stroke during actuation of the AF/OIS actuators. This can allow for an increased reliability over other spring designs.

For instance, in some cases, a spring can comprise a vertical wire (e.g., a stilt spring) electrically connecting a camera base and an AF actuator. However, such springs may deflect during actuation of the actuators, which can leave the spring vulnerable to increased stress and reduced reliability. For example, a stilt spring may include a resilience of around 300k cycles at a ±250 micrometer (um) stroke (x/y). In contrast, a wire spring as described herein can withstand an infinite amount of cycles at a ±330 um stroke (x/y). Accordingly, the wire spring as described herein can comprise an increased resiliency over other spring designs.

Further, a wire spring as described herein can include a down force on a bearing to achieve a near-zero dynamic tilt impact. The flattening of the wire bends in the wire springs can provide a down force (e.g., of around 25 millinewtons), but only occupy around 0.2 mm of z space in the camera assembly. This can provide for a minimal impact to required height of a camera assembly.

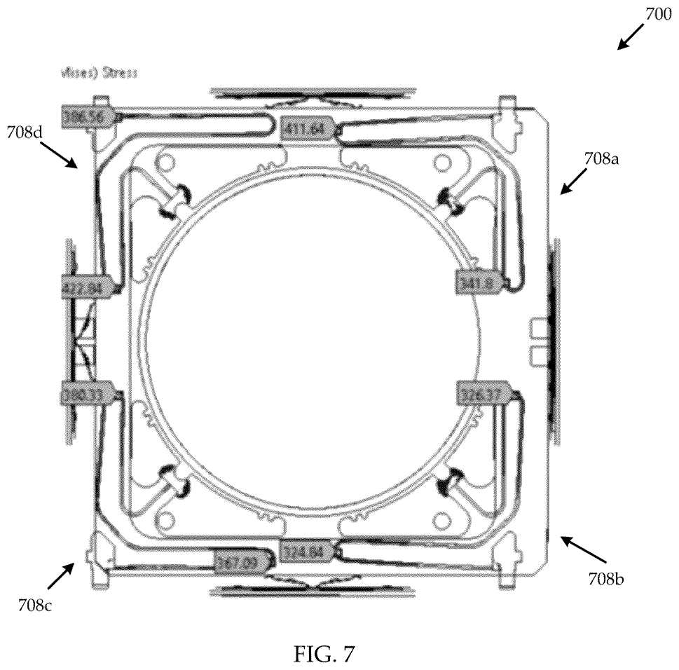

FIG. 7 illustrates a top view of an actuator 700 comprising a set of wire springs engaged to an OIS actuator. While four wire springs 708a-d are shown, the embodiments as described herein are not limited to such examples, as any number of wire springs can be disposed in a system as described herein.

Each wire spring 708a-d can be disposed within the OIS actuator. Further, a maximum stroke motion of the OIS actuator can be around ±330 um (x/y). A maximum stress on the flat wire springs can be around 423 megapascals (Mpa). Such a stress on the wire springs can be below an infinite fatigue stress limit, indicating a minimal or no fatigue on the wire springs during multiple actuation cycles. For instance, the wire springs can comprise a maximum stress of 423 Mpa, while an infinite fatigue limit can be 1276 Mpa/2=˜638 Mpa.

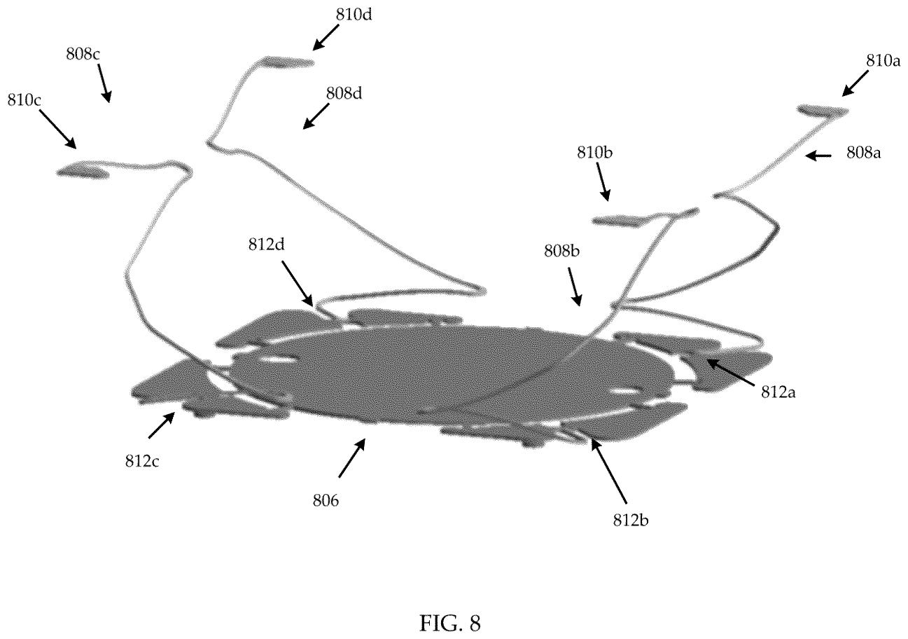

FIG. 8 illustrates the set of wire springs 808a-d in a free formed state. As shown in FIG. 8, a second end 812a-d of each of the wire springs 808a-d can be connected to a base portion 806. The base portion 806 can include a base of the OIS actuator as described herein.

Further, each wire spring 808a-d can include a first end comprising a foot portion 810a-d. The first ends 810a-d of each wire spring 808a-d can be configured to be affixed (welded, soldered) to a base portion of the AF actuator.

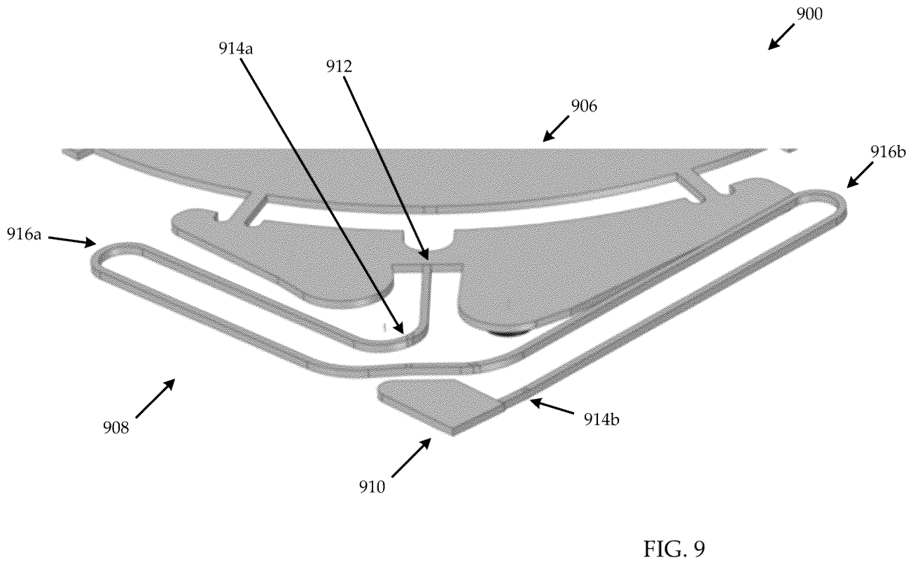

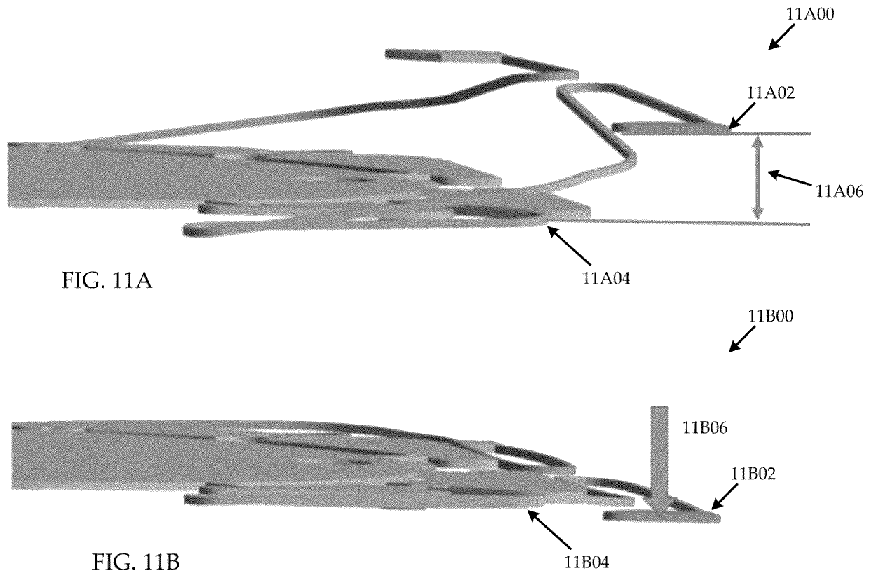

The embodiment in FIG. 8 illustrates the wire springs in a free formed state, which can include a state where a tool can clamp the center flat plate section (806 and 812a-d), and another clamp can hold the 4 outer pads or feet (810a-d), then the two clamps can move 6.4 mm relative to each other in the Z-direction. The spring arms can then plastically deform at the higher stress locations along their length which is based on spring design. The spring can then spring back a certain amount in the Z-direction and look like the springs as depicted in FIG. 11A, for example. Further, a precision bend form can clamp the material top and bottom and then push up on the material close to the clamp to localize the plastic deformation of the material between the clamp and pushing tool at a precise, defined location. In some instances, the flattening bends can be put in (e.g., as shown in FIG. 9) prior to the putting in the pre-load with the free form as is described with reference to FIG. 8.

A pre-load force can be applied to each of the wire springs. The pre-load force can apply a down force on each of the wire springs to prevent negative z-direction movement of the wire springs. For instance, the wire springs can be free formed by 6.4 mm to create a pre-load. A higher pre-load force can have a higher arm deflection. For example, a 25 mN pre-load can include a total Z deflection of about 0.5 mm. Further, flattening bends can be added prior to free forming the wire springs, which can further reduce arm deflection to 0.1 mm (or a 0.2 mm full height).

FIG. 9 illustrates an example flattened wire spring 908. As shown in FIG. 9, the wire spring 908 can be flattened to be substantially flat with the base 906. The wire spring 908 can include a downforce of around 25 millinewtons.

Further, in FIG. 9, the wire spring 908 can include a first end 910 and a second end 912. The wire spring 908 can include flattening bends 914a-b. The flattening bends 914a-b can include a first bend 914a with an angle of +3.5 degrees and a second bend 914b with an angle of −3.5 degrees, respectively. The wire spring 908 can also include angle bend portions 916a-b. The angle bend portions 916a-b can comprise a rounded angle to provide around a 180 degree bend to the wire spring 908.

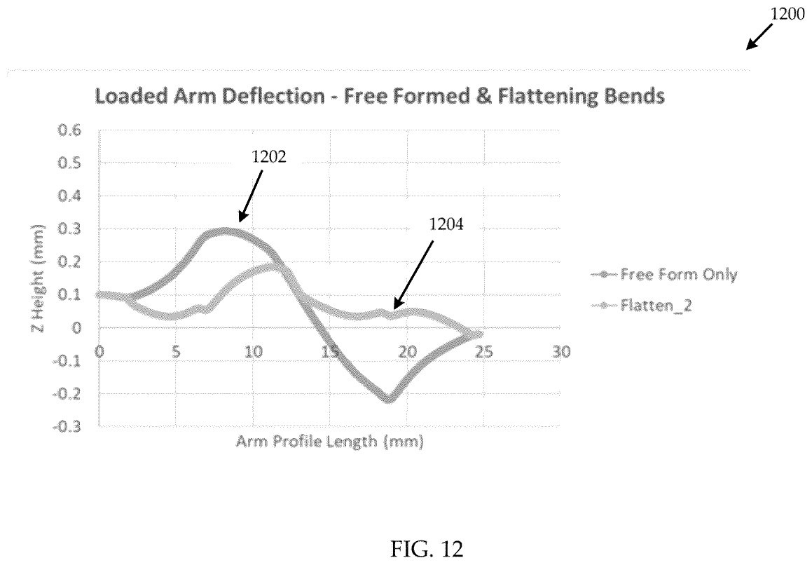

FIG. 12 is a graphical illustration 1200 illustrating a comparison of an arm profile and z-direction height of various wire springs. For example, the graphical illustration 1200 can include an x-axis illustrating an arm profile length (mm) and a y-axis illustrating a z-direction height (mm). As shown in FIG. 12, a first trendline 1202 can illustrate aspects of a free formed only wire spring. The first trendline 1202 illustrates that the z-height of the free formed only wire spring can be between +0.3 mm and −0.2 mm, for example.

Further, the second trendline 1204 can illustrate aspects of a flattened wire spring as described herein. The second trendline 1204 can illustrate that a maximum z-height of the wire spring can be around +0.2 mm with the z-height of the wire spring never going negative. The pre-load force on the wire spring can result in the wire spring not being deflected into a negative z-direction. This design may not require foot clearance in a camera apparatus, which can impact the overall height of the camera apparatus design.

In some embodiments, a system can include four spring arms for an OIS actuator. This can provide symmetry and can provide four electrical circuits to power a closed loop AF actuator that is attached to a flat OIS spring. A stiffness in the x-y directions can be between 100 and 150 N/m. This can provide centering stiffness for the OIS without impacting X/Y stroke while also driving a width and length of the spring arms.

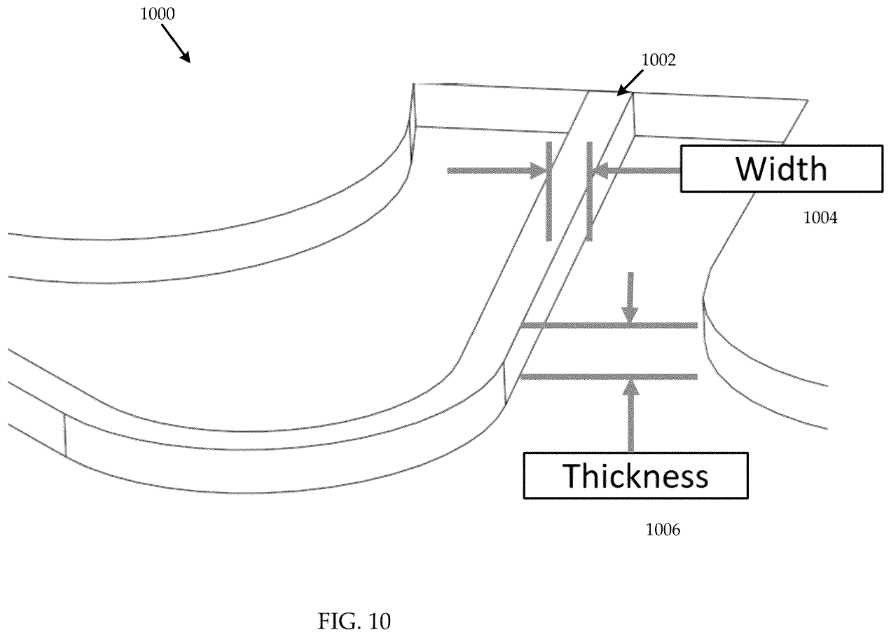

FIG. 10 illustrates a close-up view of a wire spring engaged with a base. As shown in FIG. 10, a wire spring 1002 can include a width 1004 and a thickness 1006. The width 1004 can range between 90-140 micrometers (um), with a total arm length ranging between 24-26 millimeters (mm). Further a z-preload force can be between 15-35 mN. The preload force can ensure that the OIS may not lift off planar bearings due to gravity, otherwise the lens may not be flat to the image sensor, which could blur the images captured by the image sensor. Further, a thickness 1006 can be between 0.1 and 0.15 mm. A thickness beyond this range may negatively impact X/Y stiffness, as the system may not get enough Z stiffness to achieve Z preload force. This can drive a need for forming the spring arms up so they can be pushed down farther and welded/soldered/glued for additional preload force.

FIGS. 11A-11B illustrate side views of wire springs before and after a preload force is applied. For example, as shown in FIG. 11A, the system 11A00 can include a foot portion 11A02 and a second end 11A04 attached to the base. Prior to a preload force, a spring force height 11A06 can be present between the foot portion 11A02 and the second end 11A04. After the preload force is applied, the overall height of the spring can be less than 0.25 mm.

Further, the wire spring can include one or more flattening bends and a loop. The flattening bends can be placed close to a start of each spring arm loop. A first loop can be formed downward between 1 and 6 degrees to lower a final positive height of the section of the spring arm. Further, a second loop can be formed upward between 1 and 6 degrees to reduce a final negative height of the section of the spring arm.

A preload form can include the spring arms being pulled upward to a set height and then released to allow the spring arms to spring back to a deformed height. The preload form height can be between 5-9 mm. The feet and center section of each spring arm can be parallel during the form process.

A spring back height can range between 0.6 and 2 mm. The spring feet can be deformed and spring back to a positive height about a center section. The spring arm feet can then be pushed down to a base below and then welded or soldered or glued to secure them for operation. The flattening bends can reduce the overall Z-height of the spring arms by greater than 2× smaller. For example, in FIG. 11B, a preload force 11B06 can be applied to the spring.

In a first example embodiment, a system is provided. In some instances, the system can include a camera actuating system (e.g., 600), with a first actuator comprising an autofocus actuator (e.g., 602) configured to actuate a lens in the z-direction, and a second actuator (e.g., 604) comprising an optical image stabilization actuator configured to actuate the lens in any of an x-direction and a y-direction. The system can include a first actuator (e.g., 602) comprising a first set of base portions (e.g., 606) and a second actuator (e.g., 604) comprising a second base portion (e.g., 806).

The system can further include a set of wire springs (e.g., 108a-d, 808a-d). Each of the set of wire springs can include a first end (e.g., 810a-d) connected to a corresponding portion of the first set of base portions (e.g., 106) of the first actuator. In some instances, the first end is welded to corresponding portions of the first set of base portions of the first actuator. Each wire spring can also include a second end (e.g., 812a-d) connected to the second base portion. In some instances, the second end is soldered to the second base portion. Each of the set of wire springs can allow an electrical current to flow between the first actuator and the second actuator. Each of the wire springs can also include at least two flattening bends (e.g., 914a-b) creating a down force to maintain each wire spring disposed in a positive z-direction. In some instances, each of the set of wire springs comprise a down force of around 75 millinewtons.

In some instances, each of the set of wire springs can comprise two angled bent portions (e.g., 916a-b). Further, each wire spring can include a substantially flat profile (e.g., a profile substantially similar to that of the OIS actuator). In some instances, each of the set of wire springs are configured to, in response to actuation of any of the first actuator and/or second actuator, have a maximum profile of 0.2 mm in the positive z-direction.

In another example embodiment, a wire spring is provided. The wire spring can include a first end configured to connect to a corresponding portion of a first set of base portions of a first actuator. In some instances, the first end is welded to corresponding portions of the first set of base portions of the first actuator. The wire spring can also include a second end configured to connect to a second base portion of a second actuator. In some instances, the second end is soldered to the second base portion. The wire spring can allow an electrical current to flow between the first actuator and the second actuator. The wire spring can also include at least two flattening bends creating a down force to maintain each wire spring disposed in a positive z-direction.

In some instances, the wire spring is part of a set of wire springs. Each of the set of wire springs can be configured to connect to corresponding portions of the first set of base portions of the first actuator. In some instances, the wire spring comprises two angled bent portions, wherein the wire spring comprises a substantially flat profile. In some instances, the wire spring is configured to, in response to actuation of any of the first actuator and/or second actuator, have a maximum profile of 0.2 mm in the positive z-direction. In some instances, the wire spring comprises a down force of around 25 millinewtons.

In another example embodiment, a camera actuation system is provided. The camera actuation system can include an autofocus actuator comprising a first set of base portions. The autofocus actuator can be configured to actuate a lens in a z-direction. The camera actuation system can also include an optical image stabilization actuator comprising a second base portion. The optical image stabilization actuator can be configured to actuate the lens in any of an x-direction and a y-direction.

The camera actuation system can also include a set of wire springs. Each of the set of wire springs can be connected at a first end to a corresponding portion of the first set of base portions of the autofocus actuator and connected at a second end to the second base portion.

In some instances, the set of wire springs comprise a stainless-steel material. Each of the set of wire springs can allow an electrical current to flow between the autofocus actuator and the optical image stabilization actuator. In some instances, each of the set of wire springs comprise at least two flattening bends creating a down force to maintain each wire spring disposed in a positive z-direction. In some instances, each of the set of wire springs comprise two angled bent portions, wherein each wire spring comprises a substantially flat profile. In some instances, the first end of each of the set of wire springs is welded to corresponding portions of the first set of base portions of the first actuator, and the second end of each of the set of wire springs is soldered to the second base portion. In some instances, any of the autofocus actuator and/or the optical image stabilization actuator comprise shape memory alloy (SMA) actuators including an SMA material configured to actuate in response to an electrical current being provided to the SMA material.

It will be understood that terms such as “top,” “bottom,” “above,” “below,” and x-direction, y-direction, and z-direction as used herein as terms of convenience that denote the spatial relationships of parts relative to each other rather than to any specific spatial or gravitational orientation. Thus, the terms are intended to encompass an assembly of component parts regardless of whether the assembly is oriented in the particular orientation shown in the drawings and described in the specification, upside down from that orientation, or any other rotational variation.

It will be appreciated that the term “present invention” as used herein should not be construed to mean that only a single invention having a single essential element or group of elements is presented. Similarly, it will also be appreciated that the term “present invention” encompasses a number of separate innovations, which can each be considered separate inventions. Although the present invention has been described in detail with regards to the preferred embodiments and drawings thereof, it should be apparent to those skilled in the art that various adaptations and modifications of embodiments of the present invention may be accomplished without departing from the spirit and the scope of the invention. Additionally, the techniques described herein could be used to make a device having two, three, four, five, six, or more generally n number of bimorph actuators and buckle actuators. Accordingly, it is to be understood that the detailed description and the accompanying drawings as set forth hereinabove are not intended to limit the breadth of the present invention, which should be inferred only from the following claims and their appropriately construed legal equivalents.

What is claimed is:

1. A system comprising:
a first actuator comprising a first set of base portions;
a second actuator comprising a second base portion; and
a set of wire springs, wherein each of the set of wire springs comprise:
a first end connected to a corresponding portion of the first set of base portions of the first actuator;
a second end connected to the second base portion, wherein each of the set of wire springs allow an electrical current to flow between the first actuator and the second actuator; and
at least two flattening bends to maintain each wire spring disposed in a positive z-direction, wherein the set of wire springs include a preload to generate a down force on the set of wire springs.

2. The system of claim 1, wherein the system comprises a camera actuating system, with the first actuator comprising an autofocus actuator configured to actuate a lens in the z-direction, and the second actuator comprising an optical image stabilization actuator configured to actuate the lens in any of an x-direction and a y-direction.

3. The system of claim 1, wherein each of the set of wire springs comprise two angled bent portions, wherein each wire spring comprises a substantially flat profile.

4. The system of claim 1, wherein the first end is welded to corresponding portions of the first set of base portions of the first actuator.

5. The system of claim 1, wherein the second end is soldered to the second base portion.

6. The system of claim 1, wherein each of the set of wire springs are configured to, in response to actuation of any of the first actuator and/or second actuator, have a maximum profile of around 0.2 mm in the positive z-direction.

7. The system of claim 1, wherein each of the set of wire springs comprises a down force of around 25 millinewtons.

8. A wire spring comprising:
a first end configured to connect to a corresponding portion of a first set of base portions of a first actuator;
a second end configured to connect to a second base portion of a second actuator, wherein the wire spring allows an electrical current to flow between the first actuator and the second actuator;
at least two flattening bends to maintain each wire spring disposed in a positive z-direction, wherein the wire spring includes a preload to generate a down force on the wire spring.

9. The wire spring of claim 8, wherein the wire spring is part of a set of wire springs, wherein each of the set of wire springs are configured to connect to corresponding portions of the first set of base portions of the first actuator.

10. The wire spring of claim 8, wherein the wire spring comprises two angled bent portions, wherein the wire spring comprises a substantially flat profile.

11. The wire spring of claim 8, wherein the first end is welded to corresponding portions of the first set of base portions of the first actuator.

12. The wire spring of claim 8, wherein the second end is soldered to the second base portion.

13. The wire spring of claim 8, wherein wire spring is configured to, in response to actuation of any of the first actuator and/or second actuator, have a maximum profile of around 0.2 mm in the positive z-direction.

14. The wire spring of claim 8, wherein the wire spring comprise a down force of around 25 millinewtons.

15. A camera actuation system comprising:
an autofocus actuator comprising a first set of base portions, the autofocus actuator configured to actuate a lens in a z-direction;
an optical image stabilization actuator comprising a second base portion, the optical image stabilization actuator configured to actuate the lens in any of an x-direction and a y-direction; and
a set of wire springs, wherein each of the set of wire springs are connected at a first end to a corresponding portion of the first set of base portions of the autofocus actuator and connected at a second end to the second base portion.

16. The camera actuation system of claim 15, wherein the set of wire springs comprise a stainless-steel material, wherein each of the set of wire springs allow an electrical current to flow between the autofocus actuator and the optical image stabilization actuator.

17. The camera actuation system of claim 15, wherein each of the set of wire springs comprise at least two flattening bends to maintain each wire spring disposed in a positive z-direction.

18. The camera actuation system of claim 15, wherein any of the autofocus actuator and/or the optical image stabilization actuator comprise shape memory alloy (SMA) actuators including an SMA material configured to actuate in response to an electrical current being provided to the SMA material.

19. The camera actuation system of claim 15, wherein each of the set of wire springs comprise two angled bent portions, wherein each wire spring comprises a substantially flat profile.

20. The camera actuation system of claim 15, wherein the first end of each of the set of wire springs is welded to corresponding portions of the first set of base portions of the first actuator, and wherein the second end of each of the set of wire springs is soldered to the second base portion.
